(19) United States
(12) Patent Application Publication
(10) Pub. No.: US 2023/0177425 A1
(43) Pub. Date: Jun. 8, 2023

(54) SYSTEM AND METHOD FOR RESOURCE ALLOCATION OPTIMIZATION FOR TASK EXECUTION

(71) Applicant: Bank of America Corporation, Charlotte, NC (US)

(72) Inventors: Jason Sy Coady, Harrison, NJ (US); Stephen David Pearce, Concord, NC (US); Ayeesha Sachedina, New York, NY (US); Paul Michael Dalmaine, Weehawken, NJ (US); Anthony Edward Copeland, Charlotte, NC (US); James Kyle Snyder, Charlotte, NC (US); Joseph Temitope Arewa, Newark, NJ (US); Clay Alexander Banks, Roscoe, NY (US)

(21) Appl. No.: 17/541,750

(22) Filed: Dec. 3, 2021

(51) Int. Cl. G06Q 10/06

(52) U.S. Cl. CPC G06Q 10/06313; G06Q 10/063112; G06Q 10/063118; G06Q 10/0633

(57) ABSTRACT

A system configured to optimize resource allocation efficiency obtains a task. The system identifies a set of task features associated with the task, where the task features include a description, requirements, time criticality level, resource needs with respect to the task. The system identifies one or more entities impacted by the task. The system notifies the one or more entities to update the task features. The system receives the updated task features. The system determines a performance level associated with the task based on the updated task features. The system determines a priority level for performing the task based on the performance level and the updated task features such that a predefined rule is met. The predefined rule is defined to optimize at least one of task completion time, task result quality, and resource allocation efficiency.

### TECHNICAL FIELD

The present disclosure relates generally to inter-process communication and software development, and more specifically to a system and method for resource allocation optimization for task execution.

### BACKGROUND

Within an organization, limited resources are shared among numerous development groups. The resources may include processing and memory resources. The development groups compete for the same resources from shared resources to perform tasks. In current technology, the process of evaluating tasks is done manually. Further, the process of evaluating tasks is local to each group within the organization. This process suffers from errors.

### SUMMARY

The system described in the present disclosure is particularly integrated into a practical application of optimizing resource allocation for executing tasks. This, in turn, provides an additional practical application of improving resource allocation efficiency. Thus, technology disclosed in the present disclosure facilitates performing and completing a task with less resources as opposed to the existing resource allocation technologies. As such, technology disclosed in the present disclosure improves resource allocation technologies. Further, technology disclosed in the present disclosure improves underlying operations of computing systems that are tasked with executing the tasks. These practical applications are described below.

This disclosure contemplates systems and methods configured to optimize resource allocation for executing tasks. Further, this disclosure contemplates an integrated platform (e.g., a software, mobile, web application) where an end-to-end flow of a task from conception to evaluation, prioritization, and execution can be viewed by users in real-time. The users can access each task on the application and provide additional information and feedback about the process of the task. The disclosed system may use the user input and feedback to further optimize the resource allocation for executing the tasks.

In an example scenario, assume that a user (e.g., a developer) submits a task for approval by a group manager. Examples of the task may include developing a web, software, and/or mobile application that is configured to perform a particular task, providing a service to a client, and/or any other task.

The user may submit the task on a graphical user interface of an application, for example, by filling out a templatized task intake form. For example, the user may input a description of the task, one or more entities (e.g., groups of users or developers) that are impacted by the task, and/or other information about the task. The submitted task may be viewed on the application.

From the task intake form, the disclosed system may identify task features. for example, the task features may include the description, set of requirements, time criticality level, and resource needs with respect to the task. The disclosed system may identify the one or more entities that are impacted by the task. The disclosed system may generate one or more notifications for the one or more entities, where the one or more notifications may indicate to update the task features. The disclosed system may communicate the one or more notifications to the one or more entities. For example, upon approval by the group manager, the disclosed system may generate and communicate the one or more notifications to the one or more entities. In response, the disclosed system may receive an updated set of task features from the one or more entities. For example, the one or more entities may provide the updated set of task features on the application. The disclosed system may receive the updated set of task features.

The disclosed system may determine a performance level of the task based on the updated set of task features. For example, the performance level of the task may indicate a yield percentage result of the task, e.g., 80%, 85%, etc. The disclosed system may determine a priority level for performing the task based on the performance level and the updated set of task features such that a predefined rule is met. For example, the predefined rule may be defined to optimize one or more parameters comprising a task completion time, a task result quality, and the resource allocation efficiency for performing the task. For example, in determining a priority level of performing a task, the capacity that is required to complete the task (e.g., processing, memory, etc.) may be compared against the capacity that is available in the organization.

In one embodiment, a system for optimizing resource allocation for task execution comprises a memory and a processor. The memory is operable to store a set of tasks. The processor is operably coupled with the memory. The processor obtains the set of tasks. For a first task from among the set of tasks, the processor identifies a first set of task features associated with the first task. The first set of task features comprises at least one of descriptions, a first set of requirements, a first time criticality level, and a first resource needs level with respect to the first task. The processor identifies one or more first entities that are impacted by the first task. The processor notifies the one or more first entities to update the first set of task features. The processor receives the first updated set of task features from the one or more first entities. The processor determines a first performance level associated with the first task based at least in part upon the first updated set of task features. The processor determines the first priority level for performing the first task based at least in part upon the first performance level and the first updated set of task features such that a predefined rule is met.

The disclosed system provides several practical applications and technical advantages, which include, at least: 1) technology that optimizes resource allocation for executing tasks such that a predefined rule is met, where the resource allocation is based on task features and priority levels of the tasks, and the predefined rule is defined to optimize one or more parameters comprising a task completion time, a task result quality, and optimizing the efficiency of allocation of resources for performing the task; 2) technology that compares the execution of tasks and evaluates the progress of the execution of the tasks based on feedback on the tasks and efficiency of resources allocated to the tasks; and 3) technology that provides an integrated platform (e.g., a software, web, mobile application) where an end-to-end flow of a task from conception to evaluation, prioritization, and execution can be streamlined and viewed by users in real-time.

As such, the disclosed system may be integrated into a practical application of optimizing resource allocation for executing tasks. For example, by implementing the disclosed system fewer resources may be used to perform the same task compared to the current resource allocation technology. Thus, the disclosed system may improve current resource allocation technology. Further, the disclosed system may improve the initial evaluation of tasks through a comprehensive analysis of tasks that identifies interconnections between the tasks, e.g., by identifying how tasks are dependent to one another.

Further, the disclosed system may improve task execution efficiency. For example, by implementing the disclosed system, the same task may be performed in less time, with higher quality, higher performance level, higher yield results compared to the current technology, higher degree of accuracy in task analysis and resource allocation, and delivering higher performance in a shorter amount of time.

The disclosed system may further be integrated into an additional practical application of improving the underlying operations of systems, including computing systems and databases that serve to perform the tasks. For example, by optimizing the resource allocation where less memory and storage capacity is used to perform a task, less storage capacity of a database that is employed to perform the task is occupied. This, in turn, provides an additional practical application of improving memory and storage capacity utilization. In another example, by optimizing the resource allocation where less processing resources are used to perform a task, less processing capacity of a computer system that is employed to perform the task is occupied. This, in turn, provides an additional practical application of improving the processing capacity utilization.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system configured to resource allocation optimization for task execution;

FIG. 2 illustrates an example operational flow of the system of FIG. 1; and

FIG. 3 illustrates an example flowchart of a method for resource allocation optimization for task execution.

### DETAILED DESCRIPTION

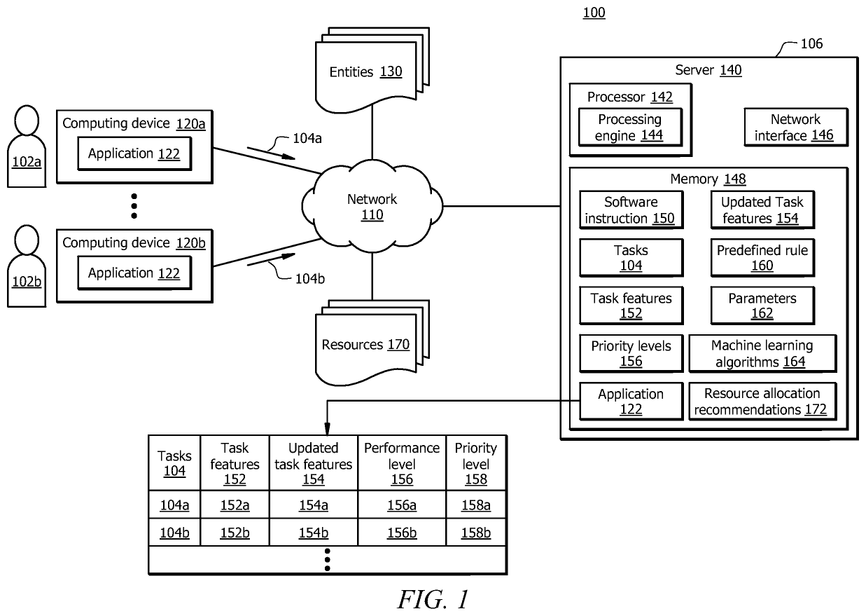

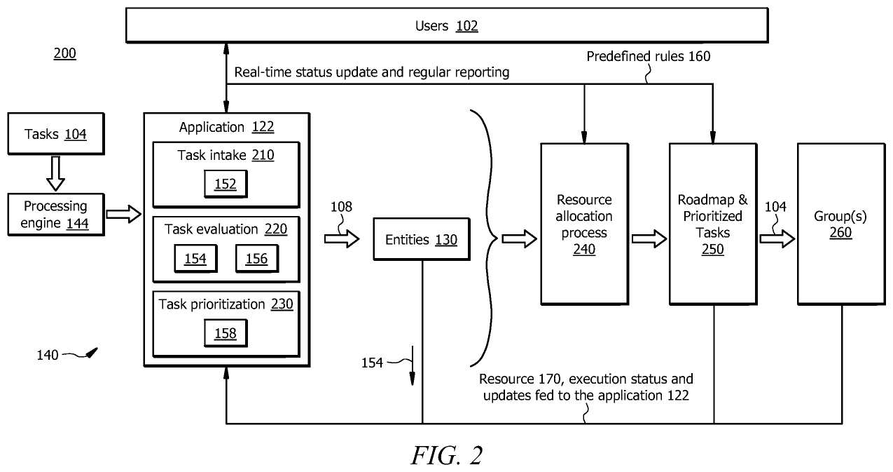

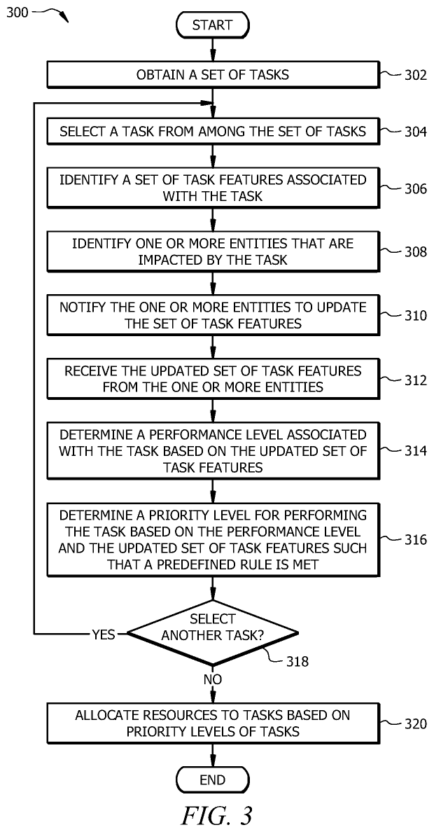

As described above, previous technologies fail to provide efficient and reliable solutions to optimize resource allocation for task execution. This disclosure provides various systems and methods to optimize resource allocation for task execution. FIG. 1 illustrates a system 100 configured to optimize resource allocation for task execution. FIG. 2 illustrates an operational flow 200 of the system 100 of FIG. 1. FIG. 3 illustrates a method 300 configured to optimize resource allocation for task execution.

Example System for Resource Allocation Optimization for Task Execution FIG. 1 illustrates one embodiment of a system 100 that is configured to implement resource allocation optimization for executing tasks 104. In one embodiment, system 100 comprises a server 140. In some embodiments, system 100 further comprises a network 110, one or more computing devices 120, one or more entities 130, and resources 170. Network 110 enables communication between components of the system 100. Server 140 comprises a processor 142 in signal communication with a memory 148. Memory 148 stores software instructions 150 that when executed by the processor 142, cause the processor 142 to perform one or more functions described herein. For example, when the software instructions 150 are executed, the processor 142 executes a processing engine 144 to determine a priority level 158 associated with a task 104, and implement resource allocation optimization for executing the task 104. In other embodiments, system 100 may not have all of the components listed and/or may have other elements instead of, or in addition to, those listed above.

In general, system 100 may receive a set of tasks 104, for example, communicated from computing devices 120. Each task 104 may be related to an implementing a different task, such as developing a new software, web, and/or mobile application, providing a service to a client, and/or any other tasks. The system 100 may perform the following operations for each task 104 from among the set of tasks 104. The system 100 may determine a set of task features 152 associated with the task 104. For example, the set of task features 152 may include a description, a set of requirements, a time criticality level, a resource need level, and a complexity level with respect to the task 104. The system 100 may determine one or more entities 130 impacted by the task 104. For example, the one or more entities 130 may include one or more groups in an organization who would be involved in an aspect of performing the task 104, such as a development group, etc. The system 100 may notify the one or more entities 130 to update the task features 152. Thus, additional information about the task 104 can be determined. The system 100 may receive the updated set of task features 154 from the one or more entities 130. The system 100 may determine a performance level 156 associated with the task 104 based on the updated set of task features 154. The system 100 may determine a priority level 158 for preforming the task 104 based on the performance level 156 and the updated set of task features 154 such that a predefined rule 160 is met. In one embodiment, the predefined rule 160 may be defined to optimize one or more parameters 162 comprising a task completion time, a task result quality, and optimizing the efficiency of allocation of resources 170 for performing the task 104. The resource 170 may comprise one or more of processing and memory resources for performing the task 104.

### System Components

### Network

Network 110 may be any suitable type of wireless and/or wired network, including, but not limited to, all or a portion of the Internet, an Intranet, a private network, a public network, a peer-to-peer network, the public switched telephone network, a cellular network, a local area network (LAN), a metropolitan area network (MAN), a wide area network (WAN), and a satellite network. The network 110 may be configured to support any suitable type of communication protocol as would be appreciated by one of ordinary skill in the art.

### Computing Device

Each of computing devices 120a and 120b is an instance of a computing device 120. Computing device 120 is generally any device that is configured to process data and interact with users 102. Examples of the computing device 120 include, but are not limited to, a personal computer, a desktop computer, a workstation, a server, a laptop, a tablet computer, a mobile phone (such as a smartphone), etc. The computing device 120 may include a user interface, such as a display, a microphone, keypad, or other appropriate terminal equipment usable by user 102. The computing device 120 may include a hardware processor, memory, and/or circuitry configured to perform any of the functions or actions of the computing device 120 described herein. For example, a software application designed using software code may be stored in the memory and executed by the processor to perform the functions of the computing device 120. The system 100 may include any number of computing devices 120. For example, system 100 may include multiple computing devices 120 that are associated with an organization 106, where the server 140 is also associated with the same organization 106 and is configured to communicate with the computing devices 120, e.g., via the network 110.

### Example Application

Application 122 may be a software, web, and/or mobile application 122 that a user 102 can interact with. The application 122 may be accessed from a graphical user interface. In one embodiment, the application 122 may facilitate an intake of a task 104, a task feature determination, a task prioritization, a resource allocation prediction, a resource allocation optimization for task execution, and task scheduling functionalities and capabilities. The application 122 may represent an integrated platform where an end-to-end flow of task from conception to evaluation, prioritization, and execution can be streamlined and viewed by users 102 in real-time.

A user 102 can submit a new task 104 into the application 122. For example, when a user 102 wants to submit a task 104 into the application 122, the user 102 can access the application 122 and fill out a templatized intake form. The user 102 can provide a description of the new task 104, indicate which entities 130 would be impacted by the task 104, and provide any other information about the task 104.

Once the task 104 is submitted on the application 122, the task 104 is transmitted to the server 140 for processing. For example, in the illustrated example of FIG. 1, user 102a may submit a task 104a on the application 122 from the computing device 120a. Once the task 104a is submitted on the application 122, the task 104a is transmitted to the server 140. Similarly, the user 102b may submit the task 104b on the application 122 from the computing device 120b. Once the task 104b is submitted on the application 122, the task 104b is transmitted to the server 140. In this manner, any number of tasks 104 may be submitted on the application 122. The tasks 104 may be viewed on the graphical user interface of the application 122.

In the illustrated example of FIG. 1, assuming that tasks 104a and 104b are submitted to the application 122, one or more aspects of each of tasks 104a and 104b can be viewed on the application 122. For example, with respect to task 104a, task features 152a, updated task features 154a, performance level 156a, priority level 158a, and/or any other information about the task 104a can be viewed on the application 122. Similarly, with respect to task 104b, task features 152b, updated task features 154b, performance level 156b, priority level 158b, and/or any other information about the task 104b can be viewed on the application 122. Users 102 can access each task 104 from the graphical user interface of the application 122.

In one embodiment, the users 102 and authorities can provide feedback and/or additional information for each task 104 on the graphical user interface of the application 122. The server 140 may use the provided feedback and/or additional information to update one or more aspects of a task 104, such as task features 152, updated task features 154, performance level 156, and/or priority level 158.

In some cases, a task 104 may be related to and/or depend on one or more other tasks 104. Thus, in one embodiment, dependencies of each task 104 may be illustrated on the graphical user interface of the application 122, for example, by lines connecting the task 104 to its dependencies.

Each of the entities 130 may include a group in the organization 106. For example, a first entity 130 may be a development group, a second entity may be a production group, etc. Each entity 130 may receive a notification to update task features 152 associated with a task 104 from the server 140. Each entity 130 may provide the update and/or additional information about the task features 152 by accessing the application 122 and inputting the updates and/or additional information to the task 104 visible on the graphical user interface of the application 122.

### Server

Server 140 is generally a device that is configured to process data and communicate with computing devices (e.g., computing devices 120), databases, systems, etc., via the network 110. The server 140 is generally configured to oversee the operations of the processing engine 144, as described further below in conjunction with the operational flow 200 of system 100 described in FIG. 2 and method 300 described in FIG. 3.

Processor 142 comprises one or more processors operably coupled to the memory 148. The processor 142 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). For example, one or more processors 142 may be implemented in cloud devices, servers, virtual machines, and the like. The processor 142 may be a programmable logic device, a microcontroller, a microprocessor, or any suitable combination of the preceding. The one or more processors are configured to process data and may be implemented in hardware or software. For example, the processor 142 may be 8-bit, 16-bit, 32-bit, 64-bit, or of any other suitable architecture. The processor 142 may include an arithmetic logic unit (ALU) for performing arithmetic and logic operations, registers the supply operands to the ALU and store the results of ALU operations, and a control unit that fetches instructions from memory and executes them by directing the coordinated operations of the ALU, registers and other components. The one or more processors are configured to implement various instructions. For example, the one or more processors are configured to execute instructions (e.g., software instructions 150) to implement the processing engine 144. In this way, processor 142 may be a special-purpose computer designed to implement the functions disclosed herein. In an embodiment, the processor 142 is implemented using logic units, FPGAs, ASICs, DSPs, or any other suitable hardware. The processor 142 is configured to operate as described in FIGS. 1-3. For example, the processor 142 may be configured to perform one or more steps of method 300 as described in FIG. 3.

Network interface 146 is configured to enable wired and/or wireless communications (e.g., via network 110). The network interface 146 is configured to communicate data between the server 140 and other devices (e.g., computing devices 120), databases, systems, or domains. For example, the network interface 146 may comprise a WIFI interface, a local area network (LAN) interface, a wide area network (WAN) interface, a modem, a switch, or a router. The processor 142 is configured to send and receive data using the network interface 146. The network interface 146 may be configured to use any suitable type of communication protocol as would be appreciated by one of ordinary skill in the art.

Memory 148 may be volatile or non-volatile and may comprise a read-only memory (ROM), random-access memory (RAM), ternary content-addressable memory (TCAM), dynamic random-access memory (DRAM), and static random-access memory (SRAM). Memory 148 may be implemented using one or more disks, tape drives, solid-state drives, and/or the like. Memory 148 is operable to store the software instructions 150, tasks 104, task features 152, updated task features 154, performance levels 156, priority levels 158, predefined rule 160, parameters 162, machine learning algorithms 164, resource allocation recommendations 172, and/or any other data or instructions. The software instructions 150 may comprise any suitable set of instructions, logic, rules, or code operable to execute the processor 142.

### Processing Engine

Processing engine 144 may be implemented by the processor 142 executing the software instructions 150, and is generally configured to 1) determine a performance level 156 associated with a task 104; 2) determine a priority level 158 associated with the task 104 based on the performance level 156 and updated set of task features 154 associated with the task 104 such that a predefined rule 160 is met; and 3) optimize allocation of resources 170 for executing tasks 104 based on the determined performance levels 156 and priority levels 158. Each of these operations of the processing engine 144 is described in detail further below in conjunction with the operational flow 200 of system 100 illustrated in FIG. 2 and method 300 illustrated in FIG. 3. The corresponding description below includes a brief explanation of certain operations of the processing engine 144.

In one embodiment the processing engine 144 may be implemented by a machine learning algorithm 164. For example, the machine learning algorithm 164 may comprise a support vector machine, neural network, random forest, k-means clustering, etc. In another example, the machine learning algorithm 164 may be implemented by a plurality of neural network (NN) layers, Convolutional NN (CNN) layers, Long-Short-Term-Memory (LSTM) layers, Bi-directional LSTM layers, Recurrent NN (RNN) layers, and the like. In another example, the machine learning algorithm 164 may be implemented by Natural Language Processing (NLP).

The processing engine 144 (e.g., via the machine learning algorithm 164) may perform a predictive analysis in order to optimize the allocation of resources 170 for executing the tasks 104. In this process, the processing engine 144 may determine a more optimal resource allocation for executing the tasks 104 by simulating various resource allocation scenarios to different tasks 104, predicting the efficiency of each simulated resource allocation scenario, and predicting which simulated resource allocation scenario yields a more optimal performance level 156 and resource allocation efficiency.

The processing engine 144 may provide one or more recommendations of resource allocation scenarios (i.e., resource allocation recommendations 172) that yield a more optimal performance level 156, such as a performance level 156 that is more than a threshold percentage, e.g., more than 80%, 85%, etc. and/or yield a more resource allocation efficiency, such as a resource allocation efficiency that is more than a threshold percentage, e.g., more than 80%, 85%, etc. The processing engine 144 may provide the one or more resource allocation recommendations 172 on the application 122, e.g., to the users 102.

In certain embodiments, the processing engine 144 may determine the resource allocation recommendations 172 based feedback and/or input from uses 102 (and/or authorities), task features 152, updated task features 154, performance levels 156, priority levels 158, an algorithm for optimizing a task completion time, an algorithm for optimizing a task result quality, an algorithm for optimizing a resource allocation efficiency. Thus, in certain embodiments, the machine learning algorithm 164 may include any combination of supervised, semi-supervised, and unsupervised machine learning algorithm 164. For example, the processing engine 144 may learn from the user inputs and/or feedback to determine the priority levels 158 of tasks 104 over time and use that information to determine the one or more resource allocation recommendations 172. In another example, the processing engine 144 may be trained by a training dataset that includes the prioritized tasks 250 and their corresponding information (e.g., features 152, updated features 154, performance level 156, allocated resources 170, and priority level 158) and tasks 104 that have been assigned to group(s) 260. The processing engine 144 may use this information to predict aspects of future tasks 104 (e.g., their performance levels 156, allocated resources 170, and priority levels 158) based on comparing their features 152 and/or updated features 154 with the features 152 and/or updated features 154 of the current tasks 104 and determining that a current task 104 has corresponding (or matching) features 152 and/or updated features 154 with a future task 104. This process is described in more detail below in conjunction with the operational flow 200 of system 100 illustrated in FIG. 2.

Resources 170 may include processing and memory resources. In certain embodiments, the resources 170 may include a cloud of computing devices, such as virtual machines, that may be allocated to perform a task 104. In certain embodiments, the resources 170 may include a cloud of databases that may be used as storage capacities for performing a task 104. In certain embodiments, resources 170 may include a number of users, e.g., developers assigned to perform the task 104.

In certain embodiments, the processing engine 144 may be configured to detect dependencies of a particular task 104 by comparing the particular task 104 with historical tasks 104 and implementing a natural language processing on the description of the task 104 and/or other task features 152. For example, assume that a historical task 104 has been identified to have certain dependencies. The processing engine 144 may compare the task features 152 and/or updated task features 154 of historical task 104 with the task features 152 and/or updated task features 154 of a particular task 104. If the processing engine 144 determines that there is more than a threshold percentage (e.g., more than 80%, 85%, etc.) correspondence between the task features 152 and/or updated task features 154 of the historical task 104 and the particular task 104, the processing engine 144 may recommend to add the certain dependencies of the historical task 104 to the particular task 104. In other words, the processing engine 144 may predict and determine that the certain dependencies of the historical task 104 should be added to the particular task 104.

Similarly, the processing engine 144 may recommend to assign entities 130 that are impacted by the historical task 104 to the particular task 104, if it is determined that there is more than a threshold percentage (e.g., more than 80%, 85%, etc.) correspondence between the task features 152 and/or updated task features 154 of the historical task 104 and the particular task 104. Similarly, the processing engine 144 may recommend to allocate similar (or the same type of resources 170) to the particular task 104 that the historical task 104 is allocated with. Similarly, the processing engine 144 may recommend to assign a similar (or the same priority level 158) the particular task 104 that the historical task 104 is associated with.

### Example Operational Flow

FIG. 2 illustrates an example operational flow 200 of system 100 of FIG. 1. In one embodiment, the operational flow 200 may begin when one or more tasks 104 are submitted on the application 122 accessed on the computing devices 120, similar to that described above in FIG. 1. This process may be referred to as task intake operation 210. The one or more tasks 104 are transmitted to the server 140 from the computing devices 120, via the application 122 for processing. The processing engine 144 may obtain the set of tasks 104. In one embodiment, throughout the operational flow 200, real-time status updates with respect to each task 104 is presented on the application 122 and/or communicated to the users 102. In one embodiment, a threshold number of tasks 104 to analyze in each stage of the operational flow 200 may be set before proceeding to the next stage. For example, assuming that the threshold number of tasks 104 to analyze in a task evaluation stage 220 is five. Thus, if five tasks 104 are being analyzed and evaluated in the task evaluation stage 220, no task 104 may be added to the task evaluation stage 220 until there is space in the task evaluation stage 220 to analyze a new task 104, i.e., a number of tasks 104 in the task evaluation stage 220 is less than five. In one embodiment, a different threshold number of tasks 104 for different stages of the operational flow 200 may be predefined. In one embodiment, throughout the operational flow 200, regular reporting (e.g., every day, every few days, etc.) with respect to each task 104 is presented on the application 122 and/or communicated to the users 102. In one embodiment, allocation of resources 170 status and updates, and task execution status and updates are presented on the application 122 and/or communicated to the users 102, e.g., in real-time, periodically (e.g., every minute, every five minutes, etc.), and/or on-demand. The processing engine 144 may perform one or more operations below for each task 104 from among the set of tasks 104.

Identifying Task Features Associated with the Task

In one embodiment, the processing engine 144 may identify a set of task features 152 associated with the task 104. For example, the set of task features 152 may include a description, a set of requirements, a time criticality level, a resource need level, and a complexity level with respect to the task 104. This process may be referred to as task evaluation operation 220.

The description of the task 104 may include text describing the task 104 provided by the user 102 who submitted the task 104. The set of requirements of the task 104 may include technological tools and/or any other requirements that are needed to perform the task 104. The time criticality level of the task 104 may indicate how critical the task completion time is. For example, if the time criticality level of the task 104 is 5 out of 5, it means that the task completion time of the task 104 is highly critical. In one embodiment, the time criticality level of the task 104 may be provided by the user 102. The resource needs level of the task 104 may indicate amount of resources 170 needed to perform the task 104. For example, the resources 170 needed for the task 104 may include one or more of processing and memory resources. In another example, the resources needed for the task 104 may include a number of group members, and specified by types of roles of the number of group members. The complexity level of the task 104 may indicate how complex performing the task 104 is. For example, if the complexity level of the task 104 is 5 out of 5, it means that the task 104 is highly complex. In one embodiment, the complexity level of the task 104 may be provided by the user 102. In one embodiment, the task features 152 may further include one or more entities 130 that are impacted by the task 104. In one embodiment, the complexity level of a task 104 may be modified according to Fibonacci scale numbers, i.e., 1, 2, 3, 5, 8, 13, 20, etc.

In one embodiment, the task features 152 may further include one or more dependencies associated with the task 104, where the one or more dependencies may include regions, technological fields, etc. related to the task 104.

Further, during the task evaluation operation 220, the processing engine 144 may identify one or more entities 130 that are impacted by the task 104. In one embodiment, the entities 130 may be provided by a user 102 who submitted the task 104 on the application 122 during the task intake operation 210.

In one embodiment, the processing engine 144 may identify the entities 130 based on the set of task features 152, e.g., by parsing and analyzing the task features 152 by implementing an object-oriented programming where each item in the task features 152 may be treated as an object.

The processing engine 144 may notify the one or more entities 130 to update the set of task features 152. In this process, the processing engine 144 may generate one or more notification requests 108 for the one or more entities 130, where the one or more notification requests 108 may indicate to update the set of task features 152.

The processing engine 144 may send the one or more notification requests 108 to the one or more entities 130. The processing engine 144 may receive the updated set of task features 154 from the one or more entities 130, for example, when the one or more entities 130 provide the additional information about the task 104 on the application 122, similar to that described in FIG. 1.

In one embodiment, the updated set of task features 154 may include additional information and details about the task 104. For example, the updated set of task features 154 may include an indication of a minimum amount of resources 170 needed to perform the task 104, an indication of minimum amount of work needed to perform the task 104, an indication of a minimum amount of group members (specified with particular roles) needed to perform the task 104, whether the task 104 needs to be communicated to an external entity, whether the task 104 needs to pass a firewall to be communicated to an external entity, whether an information security group has signed off on communicating the task 104 to an external entity, and/or any other information about the task 104.

In one embodiment, the updated set of task features 154 may be obtained in one or more stages. For example, once the task 104 is submitted on the application 122, a manager may approve the task 104. In response, the task 104 may move to a next stage (illustrated on the application 122) where entities 130 impacted by the task 104 provide additional information about the task 104 on the application 122. For example, in this stage, the additional information may include a more accurate estimation of amount of resources 170 needed to perform the task 104. A manager may approve the task 104 at this stage. In response, the task 104 may move to a next stage (illustrated on the application 122) where additional information and details including those enumerated above are added to the task 104 on the application 122. In one embodiment, the movement or progress of the task 104 to the next stage may be based on available space for a new task 104 in the next stage according to the threshold number of tasks 104 to analyze and complete in the new stage of the operational flow 200, similar to that described above.

The processing engine 144 may determine a performance level 156 associated with the task 104 based on the updated set of task features 154. In one embodiment, the performance level 156 may indicate a performance result and/or a yield result of the task 104. For example, if the updated set of task features 154 indicate that the task 104 has a high yield result (e.g., 80%, 85%, etc.) the processing engine 144 may determine that the performance level 156 of the task 104 is the determined yield result (e.g, 80%, 85%, etc.).

### Determining a Priority Level of the Task

The processing engine 144 may determine a priority level 158 for performing the task 104 based on the performance level 156 and updated set of task features 154 such that a predefined rule 160 is met. This process may be referred to as task prioritization operation 230.

In one example, assume that the performance level 156 associated with the task 104 is more than a threshold performance level (e.g., 80%, etc.) and the time criticality level of the task 104 is less than a threshold time criticality level (e.g., less than 3 out of 5). In this example, the processing engine 144 may determine that the priority level 158 is more than a threshold priority level (e.g., 85%, etc.). In another example, assume that the performance level 156 associated with the task 104 is less than the threshold performance level and the time criticality level of the task 104 is more than the threshold time criticality level, the processing engine 144 may determine that the priority level 158 is less than the threshold priority level. In one embodiment, the time criticality level of a task 104 may be modified according to Fibonacci scale numbers, i.e., 1, 2, 3, 5, 8, 13, 20, etc. In one embodiment, any other value that is used to analyze a task 104 may be modified according to Fibonacci scale numbers, i.e., 1, 2, 3, 5, 8, 13, 20, etc.

In this manner, the processing engine 144 may determine the priority levels 158 of tasks 104 based on their updated task features 154 and performance levels 156 such that the predefined rule 160 is met.

In one embodiment, the predefined rule 160 may be defined to optimize one or more parameters 162 comprising a task completion time, a task result quality, and optimizing the efficiency of allocation of resources 170 for performing the task 104.

In one embodiment, the processing engine 144 may update the priority level 158 based on feedback received from a user 102, an algorithm for optimizing a task completion time, an algorithm for optimizing a task result quality, and an algorithm for optimizing a resource allocation efficiency.

### Prioritizing Tasks and Allocating Resources to the Tasks

As noted above, the processing engine may perform the above operations for each task 104 from among the set of tasks 104. The processing engine 144 may compare the tasks 104 to rank the tasks 104 in order of their priority levels 158. The processing engine 144 may allocate resources 170 to tasks 104 based on their priority levels 158. For example, the processing engine 144 may allocate available resources 17 to a task 104 that has the highest priority level 158 before other tasks 104.

The processing engine 144 may go down the list of tasks 104 ranked based on their priority levels 158 and allocate from the available resources 170 to other tasks 104 one by one in the list of tasks 104. These processes may be performed during a resource allocation operation 240. The list of tasks 104 ranked based on their priority levels 158 may be indicated in the prioritized tasks 250.

The corresponding description below describes an example where the first task 104a and the second task 104b are evaluated. However, in one embodiment, the processing engine 144 may perform these operations for any number of tasks 104 simultaneously. In another embodiment, the processing engine 144 may perform these operations for a threshold number of tasks 104 that is predefined for a given stage of the operational flow 200, similar to that described above.

For example, with respect to the first task 104a, the processing engine 144 may identify a first set of task features 152a, identify one or more first entities 130 impacted by the first task 104a, receive first updated set of task features 154a from the first entities 130, determine a first performance level 156a based on the first updated set of task features 154a, and determine a first priority level 158a for performing the first task 104a based on the first performance level 156a and the first updated set of task features 154a such that the predetermined rule 160 is met.

Similarly, with respect to the second task 104b, the processing engine 144 may identify a second set of task features 152b, identify one or more second entities 130 impacted by the second task 104b, receive second updated set of task features 154b from the second entities 130, determine a second performance level 156b based on the second updated set of task features 154b, and determine a second priority level 158b for performing the second task 104a based on the second performance level 156b and the second updated set of task features 154b such that the predetermined rule 160 is met.

The processing engine 144 may compare the first task 104a and the second task 104b to determine which task 104 should be prioritized over the other. For example, the processing engine 144 may compare the first priority level 158a with the second priority level 158b.

In this process, the processing engine 144 may determine whether the first priority level 158a is higher than the second priority level 158b. If the processing engine 144 determines that the first priority level 158a is higher than the second priority level 158b, the processing engine 144 may prioritize the first task 104a over the second task 104b.

To this end, the processing engine 144 may allocate a set of resources 170 to the first task 104a. The processing engine 144 may send a notification to perform the first task 104a, e.g., to development group(s) 260 that are assigned to perform the first task 104a. The processing engine 144 may add the notification to the task 104a on the application 122. The processing engine 144 may place the second task 104b in a backlog or queue (e.g., in the list of prioritized tasks 250) until it is determined that the second task 104b should be prioritized over other tasks 104 in the list of prioritized tasks 250.

If the processing engine 144 determines that the second priority level 158b is higher than the first priority level 158a, the processing engine 144 may prioritize the second task 104b over the first task 104a. To this end, the processing engine 144 may allocate the set of resources 170 to the second task 104b. The processing engine 144 may send a notification to perform the second task 104b, e.g., to development group(s) 260 that are assigned to perform the second task 104b. The processing engine 144 may add the notification to the task 104b on the application 122. The processing engine 144 may place the first task 104a in a backlog or queue (e.g., in the list of prioritized tasks 250) until it is determined that the first task 104a should be prioritized over other tasks 104 in the list of prioritized tasks 250. In one embodiment, this process is performed based on a threshold number of tasks 104 to be completed in a given stage of the operational flow 200, similar to that described above.

Reallocating Resources to Another Task that has a Higher Priority Level

In one embodiment, the roadmap and prioritized tasks 250 may comprise a backlog of tasks 104 that are in a queue to be allocated resources 170 and assigned to groups 260. In other words, a roadmap of execution of tasks 104 may be indicated in the roadmap and prioritized tasks 250. Thus, the processing engine 144 may determine timing schedule of assigning particular groups 260 and allocating particular resources 170 for executing each task 104 from the roadmap and prioritized tasks 250.

In one embodiment, the processing engine 144 may reallocate resources 170 to a new task 104 from the queue of tasks 104 in the roadmap and prioritized tasks 250 if it is determined that the new task 104 has a priority level 158 that is higher than a priority level 158 of a task 104 that is already sent to group(s) 260, i.e., currently being worked on. In one embodiment, this process is performed based on a threshold number of tasks 104 to be completed in a given stage of the operational flow 200, similar to that described above. This process is described below.

For example, assume that a third task 104 is submitted on the application 122. The processing engine 144 may identify a third set of task features 152, identify one or more third entities 130 impacted by the third task 104, receive third updated set of task features 154 from the third entities 130, determine a third performance level 156 based on the third updated set of task features 154, and determine a third priority level 158 for performing the third task 104 based on the third performance level 156 and the third updated set of task features 154 such that the predetermined rule 160 is met.

If the processing engine 144 determines that the third priority level 158 of the third task 104 is higher than the particular task 104 that is already sent to group(s) 260, allocated with resources 170, and sent to group(s) 260, the processing engine 144 may reallocate the set of resources 170 (that were previously allocated to the particular task 104) to the third task 104. In other words, the processing engine 144 may swap the third task 104 with the particular task 104 that is already sent out to group(s) 260 and is in progress, i.e., the processing engine 144 may swap the third task 104 with the particular task 104 that is in the backlog or in progress (currently being worked on). The processing engine 144 may send a notification to perform the third task 104, e.g., to development group(s) 260 that are assigned to perform the third task 104.

In one embodiment, the processing engine 144 may determine a swapping cost and/or an amount of resources 170 needed to swap the third task 104 with the particular task 104. The processing engine 144 may determine not to swap the third task 104 with the particular task 104 if the swapping cost and/or the amount of resources 170 needed to swap the third task 104 with the particular task 104 is more than a threshold amount and/or number, respectively. In one embodiment, this process is performed based on a threshold number of tasks 104 to be completed in a given stage of the operational flow 200, similar to that described above.

In one embodiment, the processing engine 144 may examine an impact of a potential reallocation of resources 170 on a task 104. Reallocating resource 170 from a task 104 may affect the task 104 and its dependencies. For example, the processing engine 144 may determine tasks 104 that are dependent on a particular task 104 (i.e., dependencies of the particular task 104), similar to that described above. The processing engine 144 may further determine task features 152 and updated task features 154 of the particular task 104 and its dependencies, similar to that described above. The processing engine 144 may determine an impact of a potential reallocation of resources 170 on the particular task 104 based on an impact that the potential reallocation of resources 170 has on the particular task 104 and its dependencies, and their features 152 and updated features 154. The processing engine 144 may use this information in resource decisioning which includes resource allocation and resource reallocation.

### Example Method for Resource Allocation Optimization for Task Execution

FIG. 3 illustrates an example flowchart of a method 300 for resource allocation optimization for task execution. Modifications, additions, or omissions may be made to method 300. Method 300 may include more, fewer, or other steps. For example, steps may be performed in parallel or in any suitable order. While at times discussed as the system 100, processor 142, processing engine 144, or components of any of thereof performing operations, any suitable system or components of the system may perform one or more operations of the method 300. For example, one or more operations of method 300 may be implemented, at least in part, in the form of software instructions 150 of FIG. 1, stored on non-transitory, tangible, machine-readable media (e.g., memory 148 of FIG. 1) that when run by one or more processors (e.g., processor 142 of FIG. 1) may cause the one or more processors to perform operations 302-320.

Method 300 may begin at operation 302 when the processing engine 144 obtains a set of tasks 104. The processing engine 144 may obtain the set of tasks 104 when each task 104 is submitted on the application 122 by a user 102, similar to that described in FIGS. 1 and 2.

At step 304, the processing engine 144 selects a task 104 from among the set of tasks 104. The processing engine 144 may iteratively select a task 104 until no task 104 is left for evaluation.

At step 306, the processing engine 144 identifies a set of task features 152 associated with the task 104. For example, the set of features 152 may include a description, a set of requirements, a time criticality level, a resource need level, and a complexity level with respect to the task 104. In one embodiment, the set of task features 152 may further include one or more entities 130 impacted by the task 104. The set of task features 152 may be provided by a user 102 who submitted the task 104 on the application 122.

At step 308, the processing engine 144 identifies one or more entities 130 that are impacted by the task 104. For example, the processing engine 144 may identify the one or more entities 130 from the set of task features 152, e.g., by implementing an object-oriented programming where each item in the set of task features 152 is treated as an object.

At step 310, the processing engine 144 notifies the one or more entities 130 to update the set of task features 152. For example, the processing engine 144 may generate notification requests 108 and send them to the entities 130, similar to that described in FIGS. 1 and 2.

At step 312, the processing engine 144 receives the updated set of task features 154 from the one or more entities 130. The updated set of task features 154 may include additional information and detail about the task 104, similar to that described in FIGS. 1 and 2.

At step 314, the processing engine 144 determines a performance level 156 associated with the task 104 based on the updated set of task features 154. The performance level 156 associated with the task 104 may indicate a yield result percentage of performing the task 104, e.g., 80%, 85%, etc., similar to that described in FIG. 2.

At step 316, the processing engine 144 determines a priority level 158 associated with the task 104 based on the performance level 156 and the updated set of task features 154 such that a predefined rule 160 is met, similar to that described in FIG. 2. The predefined rule 160 may be defined to optimize one or more parameters 162 comprising a task completion time, a task result quality, and optimizing the efficiency of allocation of resources 170 for performing the task 104. In one embodiment, the parameters 162 may include a cost needed to perform and complete the task 104.

At step 318, the processing engine 144 determines whether to select another task 104 for evaluation. The processing engine 144 may select another task 104 if it is determined that at least one task 104 is left for evaluation. If the processing engine 144 determines to select another task 104, method 300 returns to step 304. Otherwise, method 300 proceeds to step 320.

At step 320, the processing engine 144 allocates resources 170 to the tasks 104 based on priority levels 158 of tasks 104, similar to that described in FIGS. 1 and 2.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U. S.C. § 112(f) as it exists on the date of filing hereof unless the words “means for” or “step for” are explicitly used in the particular claim.

1. A system for optimizing resource allocation efficiency for executing tasks comprising:
a memory operable to store a set of tasks; and
a processor, operably coupled to the memory, and configured to:
obtain the set of tasks;
for a first task from among the set of tasks:
identify a first set of task features associated with the first task, wherein the first set of task features comprises at least one of a first description, a first set of requirements, a first time criticality level, and a first resource needs with respect to the first task, wherein the first time criticality level indicates how critical a completion of the first task is;
identify one or more first entities that are impacted by the first task;
notify the one or more first entities to update the first set of task features;
receive the first updated set of task features from the one or more first entities;
determine a first performance level associated with the first task based at least in part upon the first updated set of task features;
determine a first priority level for performing the first task based at least in part upon the first performance level and the first updated set of task features such that a predefined rule is met; and
allocate a particular set of processing resources to the first task based at least in part upon the first performance level and the first priority level, wherein the particular set of processing resources is less than the first resource needs previously allocated to the first task based at least in part upon the first set of task features.

2. The system of claim 1, wherein the predefined rule is defined to optimize one or more parameters comprising a task completion time, a task result quality, and a resource allocation efficiency, wherein the resource comprises one or more of processing, and memory resources for performing a task.

3. The system of claim 1, wherein determining the first priority level for performing the first task based at least in part upon the first performance level and the first updated set of task features comprises:
if the first performance level is more than a threshold performance level and the first time criticality level is less than a threshold time criticality level, determining that the first priority level is more than a threshold priority level; and
if the first performance level is less than the threshold performance level and the first time criticality level is more than the threshold time criticality level, determining that the first priority level is less than the threshold priority level.

4. The system of claim 1, wherein the processor is further configured to:
for a second task from among the set of tasks:
identify a second set of task features associated with the second task, wherein the second set of task features comprises at least one of a second description, a second set of requirements, a second time criticality level, and a second resource needs with respect to the second task;
identify one or more second entities that are impacted by the second task;
notify the one or more second entities to update the second set of task features;
receive the second updated set of task features from the one or more second entities;
determine a second performance level associated with the second task based at least in part upon the second updated set of task features; and
determine a second priority level for performing the second task based at least in part upon the second performance level and the second updated set of task features such that the predefined rule is met.

5. The system of claim 4, wherein the processor is further configured to:
compare the first task with the second task in terms of the first priority level and the second priority level;
determine whether the first priority level is higher than the second priority level; and
in response to determining that the first priority level is higher than the second priority level:
allocate a set of resources to the first task, wherein the set of resources comprises one or more of processing and memory resources; and
send a first notification to perform the first task.

6. The system of claim 5, wherein the processor is further configured to:
in response to determining that the second priority level is higher than the first priority level:
allocate the set of resources to the second task; and
send a second notification to perform the second task.

7. The system of claim 5, wherein the processor is further configured to:
receive a third task;
identify a third set of task features associated with the third task, wherein the third set of task features comprises at least one of a third description, a third set of requirements, a third time criticality level, and a third resource needs with respect to the third task;
identify one or more third entities that are impacted by the third task;
notify the one or more third entities to update the third set of task features;
receive the third updated set of task features from the one or more third entities;
determine a third performance level associated with the third task based at least in part upon the third updated set of task features;
determine a third priority level for performing the third task based at least in part upon the third performance level and the third updated set of task features such that the predefined rule is met;
determine that the third priority level is higher than the first priority level; and
in response to determining that the third priority level is higher than the first priority level:
reallocate the set of resources to the third task; and
send a third notification to perform the third task.

8. A method for optimizing resource allocation efficiency for executing tasks comprising:
obtaining a set of tasks;
for a first task from among the set of tasks:
identifying a first set of task features associated with the first task, wherein the first set of task features comprises at least one of a first description, a first set of requirements, a first time criticality level, and a first resource needs with respect to the first task, wherein the first time criticality level indicates how critical a completion of the first task is;
identifying one or more first entities that are impacted by the first task;
notifying the one or more first entities to update the first set of task features;
receiving the first updated set of task features from the one or more first entities;
determining a first performance level associated with the first task based at least in part upon the first updated set of task features;
determining a first priority level for performing the first task based at least in part upon the first performance level and the first updated set of task features such that a predefined rule is met; and
allocating a particular set of processing resources to the first task based at least in part upon the first performance level and the first priority level, wherein the particular set of processing resources is less than the first resource needs previously allocated to the first task based at least in part upon the first set of task features.

9. The method of claim 8, wherein the predefined rule is defined to optimize one or more parameters comprising a task completion time, a task result quality, and a resource allocation efficiency, wherein the resource comprises one or more of processing, and memory resources for performing a task.

10. The method of claim 8, wherein determining the first priority level for performing the first task based at least in part upon the first performance level and the first updated set of task features comprises:
if the first performance level is more than a threshold performance level and the first time criticality level is less than a threshold time criticality level, determining that the first priority level is more than a threshold priority level; and
if the first performance level is less than the threshold performance level and the first time criticality level is more than the threshold time criticality level, determining that the first priority level is less than the threshold priority level.

11. The method of claim 8, further comprising:
for a second task from among the set of tasks:
identifying a second set of task features associated with the second task, wherein the second set of task features comprises at least one of a second description, a second set of requirements, a second time criticality level, and a second resource needs with respect to the second task;
identifying one or more second entities that are impacted by the second task;
notifying the one or more second entities to update the second set of task features;
receiving the second updated set of task features from the one or more second entities;
determining a second performance level associated with the second task based at least in part upon the second updated set of task features; and
determining a second priority level for performing the second task based at least in part upon the second performance level and the second updated set of task features such that the predefined rule is met.

12. The method of claim 11, further comprising:
comparing the first task with the second task in terms of the first priority level and the second priority level;
determining whether the first priority level is higher than the second priority level; and
in response to determining that the first priority level is higher than the second priority level:
allocating a set of resources to the first task, wherein the set of resources comprises one or more of processing and memory resources; and
sending a first notification to perform the first task.

13. The method of claim 12, further comprising:
in response to determining that the second priority level is higher than the first priority level:
allocating the set of resources to the second task; and
sending a second notification to perform the second task.

14. The method of claim 12, further comprising:
receiving a third task;
identifying a third set of task features associated with the third task, wherein the third set of task features comprises at least one of a third description, a third set of requirements, a third time criticality level, and a third resource needs with respect to the third task;
identifying one or more third entities that are impacted by the third task;
notifying the one or more third entities to update the third set of task features;
receiving the third updated set of task features from the one or more third entities;
determining a third performance level associated with the third task based at least in part upon the third updated set of task features;
determining a third priority level for performing the third task based at least in part upon the third performance level and the third updated set of task features such that the predefined rule is met;
determining that the third priority level is higher than the first priority level;
in response to determining that the third priority level is higher than the first priority level:
reallocating the set of resources to the third task; and
sending a third notification to perform the third task.

15. The method of claim 12, further comprising:
updating the first priority level based at least in part upon one or more parameters comprising feedback received from a user, an algorithm for optimizing a task completion time, an algorithm for optimizing a task result quality, and an algorithm for optimizing a resource allocation efficiency; and
updating the second priority level based at least in part upon the one or more parameters.

16. A non-transitory computer-readable medium storing instructions that when executed by a processor cause the processor to:
obtain a set of tasks;
for a first task from among the set of tasks:
identify a first set of task features associated with the first task, wherein the first set of task features comprises at least one of a first description, a first set of requirements, a first time criticality level, and a first resource needs with respect to the first task, wherein the first time criticality level indicates how critical a completion of the first task is;
identify one or more first entities that are impacted by the first task;
notify the one or more first entities to update the first set of task features;
receive the first updated set of task features from the one or more first entities;
determine a first performance level associated with the first task based at least in part upon the first updated set of task features;
determine a first priority level for performing the first task based at least in part upon the first performance level and the first updated set of task features such that a predefined rule is met; and
allocate a particular set of processing resources to the first task based at least in part upon the first performance level and the first priority level, wherein the particular set of processing resources is less than the first resource needs previously allocated to the first task based at least in part upon the first set of task features.

17. The non-transitory computer-readable medium of claim 16, wherein the predefined rule is defined to optimize one or more parameters comprising a task completion time, a task result quality, and a resource allocation efficiency, wherein the resource comprises one or more of processing, and memory resources for performing a task.

18. The non-transitory computer-readable medium of claim 16, wherein the instructions further cause the processor to:
for a second task from among the set of tasks:
identify a second set of task features associated with the second task, wherein the second set of task features comprises at least one of a second description, a second set of requirements, a second time criticality level, and a second resource needs with respect to the second task;
identify one or more second entities that are impacted by the second task;
notify the one or more second entities to update the second set of task features;
receive the second updated set of task features from the one or more second entities;
determine a second performance level associated with the second task based at least in part upon the second updated set of task features; and
determine a second priority level for performing the second task based at least in part upon the second performance level and the second updated set of task features such that the predefined rule is met.

19. The non-transitory computer-readable medium of claim 18, wherein the instructions further cause the processor to:
compare the first task with the second task in terms of the first priority level and the second priority level;
determine whether the first priority level is higher than the second priority level;
in response to determining that the first priority level is higher than the second priority level:
allocate a set of resources to the first task, wherein the set of resources comprises one or more of processing and memory resources; and
send a first notification to perform the first task.

20. The non-transitory computer-readable medium of claim 16, wherein notifying the one or more first entities comprises:
generating a notification request for the one or more first entities, wherein the notification request indicates to update the first set of task features; and
sending the notification request to the one or more first entities.
